(19) United States
(12) Patent Application Publication
(10) Pub. No.: US 2011/0142504 A1
(43) Pub. Date: Jun. 16, 2011

(54) Image forming apparatus and method thereof

(75) Inventors: Il Kwon Kang, Suwon-si (KR); Sang Cheol Moon, Suwon-si (KR)

(73) Assignee: SAMSUNG ELECTRONICS CO., LTD., Suwon (KR)

(21) Appl. No.: 12/926,491

(22) Filed: Nov. 22, 2010

(30) Foreign Application Priority Data
Dec. 14, 2009 (KR) 10-2009-124134

(51) Int. Cl. G03G 15/20

(52) U.S. Cl. 399/322

(57) ABSTRACT

Disclosed herein is an image forming apparatus and method thereof. The image forming apparatus includes a rotating member provided close to a distal end of a guide surface used to guide a printing medium to be introduced into a fusing unit. The rotating member comes into rolling contact with the printing medium to prevent jamming of the printing medium due to matter adhered to the distal end of the guide surface.

### CROSS-REFERENCE TO RELATED APPLICATIONS

This application claims the benefit of Korean Patent Application No. 10-2009-0124134, filed on Dec. 14, 2009 in the Korean Intellectual Property Office, the disclosure of which is incorporated herein by reference.

### BACKGROUND

1. Field

Example embodiments relate to an image forming apparatus and method thereof having a guide unit to guide a printing medium to be introduced into a fusing unit.

2. Description of the Related Art

Generally, image forming apparatuses form an image on a printing medium according to input image signals. Examples of image forming apparatuses may include printers, copiers, fax machines, and devices combining functions thereof.

An electro-photographic image forming apparatus includes a paper supply unit storing a plurality of printing media, a developing unit to form an image on a printing medium supplied from the paper supply unit by use of developer, a fusing unit to fuse the developer present on the printing medium, and a discharge unit to discharge outside the apparatus the printing medium having the completely formed image.

In operation of the developing unit, after forming an electrostatic latent image on a surface of a photoconductor by irradiating light to the photoconductor charged with a predetermined electric potential, the developing unit applies the developer to the electrostatic latent image to develop the electrostatic latent image into a visible developer image. A transfer roller is used to transfer the developer image formed on the photoconductor to a printing medium, and the developer image transferred to the printing medium is fixed to the printing medium while passing through the fusing unit.

A general fusing unit includes a heating roller accommodating a heat source, and a press roller arranged in contact with the heating roller to define a fusing nip therebetween. The developer image present on a surface of the printing medium is fixed to the printing medium by receiving heat and pressure as the printing medium passes between the heating roller and the press roller.

To guide a front end of the printing medium to be introduced into the fusing unit toward the fusing nip, a guide is provided at an entrance of the fusing unit to move the printing medium while coming into contact with the guide.

Since the guide comes into contact with the printing medium, impurities, such as a residue of the developer not fused to the printing medium, scattered developer therearound, etc., may be attached to a surface of the guide. The attached impurities are adhered by the extreme heat of the fusing unit, and may prevent movement of the printing medium.

### SUMMARY

Therefore, it is an aspect of the example embodiments to provide an image forming apparatus and method thereof having a guide unit to prevent jamming of a printing medium due to adhered matter.

The foregoing and/or other aspects are achieved by providing, an image forming apparatus including a paper supply unit to supply a printing medium, a developing unit to form an image on the printing medium supplied from the paper supply unit, a fusing unit to fuse an image transferred to the printing medium by applying heat and pressure to the image, and a guide unit having a guide surface to guide the printing medium into the fusing unit, wherein the guide unit includes a rotating member arranged adjacent to a distal end of the guide surface, the rotating member being rotatable while coming into rolling contact with the printing medium.

The rotating member may include a circular roller.

The distal end of the guide surface may be spaced apart from a surface of the circular roller.

A surface of the circular roller may be coated with a fluoride resin material having high release ability.

A surface of the circular roller may protrude from an extension line of the guide surface.

A rotation center of the circular roller may be arranged lower than an extension line of the guide surface.

The fusing unit may include a heating member accommodating a heat source and a press roller to press the printing medium toward the heating member, and the circular roller may have a size smaller than a diameter of a circumscribed circle tangential to the distal end of the guide surface, a surface of the heating member and a surface of the press roller.

A distance between the distal end of the guide surface and the surface of the circular roller may be in a range of about 0.5 mm to about 1.5 mm, for example, 0.5 mm to 1.5 mm.

The rotating member may include a plurality of circular rollers rotatably installed to a shaft and spaced apart from one another in an axial direction of the shaft.

At least one guide rib extending toward the shaft may be provided at the distal end of the guide surface at a position corresponding to a space between the plurality of circular rollers.

The foregoing and/or other aspects are achieved by providing, an image forming apparatus including a guide unit installed at an entrance of a fusing unit used to heat and fuse a developer image transferred to a printing medium, the guide unit having a guide surface to guide the printing medium to a fusing nip defined between a heating member and a press roller of the fusing unit, wherein a circular roller is provided at a distal end of the guide surface and is rotated to perform frictional rolling on a surface of the printing medium passing through the fusing nip.

The circular roller may be made of one of a metal and heat-resistant resin material, and a surface of the circular roller may be coated with a fluoride resin material having high release ability.

A surface of the circular roller may protrude from an extension line of the guide surface.

A rotation center of the circular roller may be arranged lower than the extension line of the guide surface.

The circular roller may have a size smaller than a diameter of a circumscribed circle tangential to the distal end of the guide surface, a surface of the heating member and a surface of the press roller.

The surface of the circular roller may be spaced apart from the distal end of the guide surface.

The image forming apparatus may further include a shaft to which the circular roller is rotatably installed, and a plurality of circular rollers may be installed to the shaft and may be spaced apart from one another in an axial direction of the shaft.

At least one guide rib extending toward the shaft may be provided at the distal end of the guide surface at a position corresponding to a space between the plurality of circular rollers.

The foregoing and/or other aspects are achieved by providing a method, including guiding a printing medium into a fusing unit by guiding the printing medium along a guide surface, rotating a circular roller against the printing medium, the circular roller located adjacent to a distal end of the guide surface to move toward the printing medium into the fusing unit, a gap between the distal end of the guide surface and the circular roller being from 0.5 mm to 1.5 mm, forming an image onto the printing medium in the fusing unit and fusing the image onto the printing medium by applying heat and pressure to the image.

The foregoing and/or other aspects are achieved by providing an apparatus including a guide unit to guide a printing medium into a fusing unit by guiding the printing medium along a guide surface, a rotation unit to rotate a circular roller against the printing medium, the circular roller located adjacent to a distal end of the guide surface to move toward the printing medium into the fusing unit, a gap between the distal end of the guide surface and the circular roller being from 0.5 mm to 1.5 mm, a forming unit to form an image onto the printing medium in the fusing unit and a fusing unit to fuse the image onto the printing medium by applying heat and pressure to the image.

Additional aspects of the example embodiments will be set forth in part in the description which follows and, in part, will be apparent from the description, or may be learned by practice of the example embodiments.

### BRIEF DESCRIPTION OF THE DRAWINGS

These and/or other aspects will become apparent and more readily appreciated from the following description of the embodiments, taken in conjunction with the accompanying drawings of which:

FIG. 1 is a view illustrating a schematic configuration of an image forming apparatus according to example embodiments;

FIG. 2 is a perspective view of a guide unit provided in a fusing unit according to example embodiments; FIG. 3 is a sectional view of the fusing unit according to example embodiments;

FIG. 4 is a view illustrating a relationship between a guide plate and a rotating member according to example embodiments; and

FIG. 5 is a view illustrating a guide unit according to example embodiments.

### DETAILED DESCRIPTION

Reference will now be made in detail to the embodiments, examples of which are illustrated in the accompanying drawings, wherein like reference numerals refer to like elements throughout.

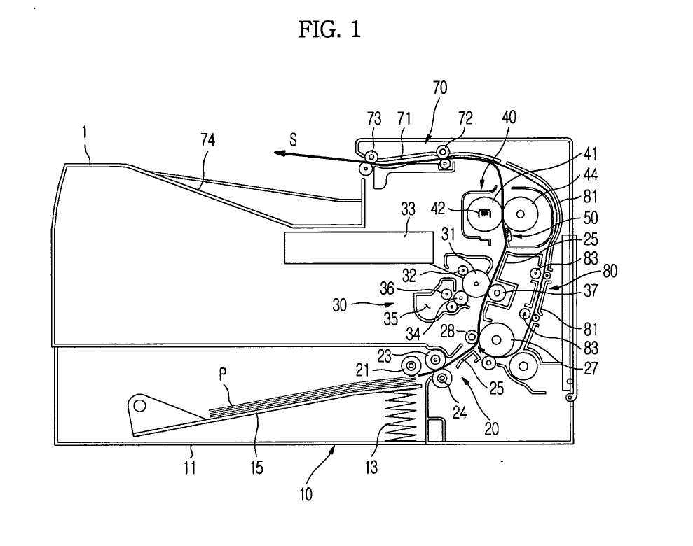

FIG. 1 is a view illustrating a schematic configuration of an image forming apparatus according to example embodiments.

Referring to FIG. 1, the image forming apparatus according to example embodiments includes a body 1 defining an exterior appearance of the image forming apparatus, a paper supply unit 10 provided in the body 1 on a printing path S of a printing medium P, a developing unit 30, a fusing unit 40, and a discharge unit 70.

The paper supply unit 10 may store and feed the printing medium P and is installed in a lower region of the body 1 to feed the printing medium P toward the developing unit 30.

The paper supply unit 10 may include a paper supply tray 11 in the form of a cassette separable from the body 1, storing the printing medium P, and a feed unit 20 to pick up the printing medium P stored in the paper supply tray 11 sheet by sheet to feed the printing medium P toward the developing unit 30.

A knock-up plate 15 may be installed in the paper supply tray 11 to guide the printing medium P stored in the paper supply tray 11 to the feed unit 20. To this end, one end of the knock-up plate 15 may be rotatably coupled to the bottom of the paper supply tray 11 and the other end may be supported by a press spring 13.

The feed unit 20 may include a pickup member 21 to pick up the printing medium P stacked on the knock-up plate 15 sheet by sheet, a feed roller 23 and a backup roller 24 to feed the printing medium P picked up by the pickup member 21 toward the developing unit 30, feed guides 25 to define the printing path S, and a register roller 27 and a backup roller 28 to align a front end of the printing medium P during movement of the printing medium P.

The developing unit 30 is arranged on the printing path S above the register roller 27 and may form an image on the printing medium P fed from the paper supply unit 10.

The developing unit 30 may include a photoconductor 31, a charge roller 32 to charge the photoconductor 31, a light scanning unit 33 to form an electrostatic latent image on a surface of the photoconductor 31 by irradiating a laser beam to the charged photoconductor 31 based on an image signal, a developing roller 34 to develop the electrostatic latent image into a developer image by attaching developer to the electrostatic latent image formed on the photoconductor 31, a supply roller 36 to supply the developer of a developer reservoir 35 to the developing roller 34, and a transfer roller 37 to transfer the image formed on the photoconductor 31 to the printing medium P.

The photoconductor 31 may serve as an image carrier to carry the developer image thereon and may be a drum. When the light scanning unit 33 irradiates a laser beam to the photoconductor 31 based on image information, the electrostatic latent image is formed on the surface of the photoconductor 31.

The charge roller 32 may charge the surface of the photoconductor 31 with a predetermined electric potential. To this end, the charge roller 32 applies electric charge to the surface of the photoconductor 31 while performing frictional rotation in contact with the surface of the photoconductor 31.

The developing roller 34 develops the electrostatic latent image formed on the photoconductor 31 into a developer image by supplying the developer to the photoconductor 31. The developing roller 34 may supply the developer to the photoconductor 31 in a contact or non-contact manner.

The supply roller 36 may supply the developer stored in the developer reservoir 35 to the developing roller 34. The developer supplied to the developing roller 34 may define a developer layer having a constant thickness under operation of a leveling member.

With the above described configuration, as the light scanning unit 33 forms an electrostatic latent image on the surface of the photoconductor 31 that has been charged with a predetermined electric potential by the charge roller 32 and the supply roller 36 and the developing roller 34 are operated to develop the electrostatic latent image using the developer stored in the developer reservoir 35, a visible image of developer powder is formed on the photoconductor 31.

The transfer roller 37 acts to press the printing medium P toward the photoconductor 31 allowing the visible image formed on the photoconductor 31 to be transferred to one surface of the printing medium P by a transfer nip as the printing medium P passes between the photoconductor 31 and the transfer roller 37.

The printing medium P, which has passed through the developing unit 30 and contains the visible image formed thereon, is guided to the fusing unit 40. To this end, one of the feed guides 25 is arranged on the printing path S above the developing unit 30.

The fusing unit 40 may heat and fuse the visible image transferred to the printing medium P. The fusing unit 40 includes a heating member 41 accommodating a heat source 42, and a press roller 44 to press the printing medium P toward the heating member 41.

The heating member 41 may be a heating roller accommodating the heat source 42 therein, or may be a heating belt to be heated by the heat source 42.

The fusing unit 40 applies heat and pressure to the visible image transferred to the printing medium P as the printing medium P passes through a fusing nip between the heating member 41 and the press roller 44 of the fusing unit 40, thereby allowing the visible image to be fused to the printing medium P.

In the example embodiments, a guide unit 50 may be installed at an entrance of the fusing unit 40 to guide the printing medium P to be introduced into the fusing unit 40. It is noted that the developer image transferred to the printing medium P is not yet fused to the printing medium P when the printing medium P enters the fusing unit 40.

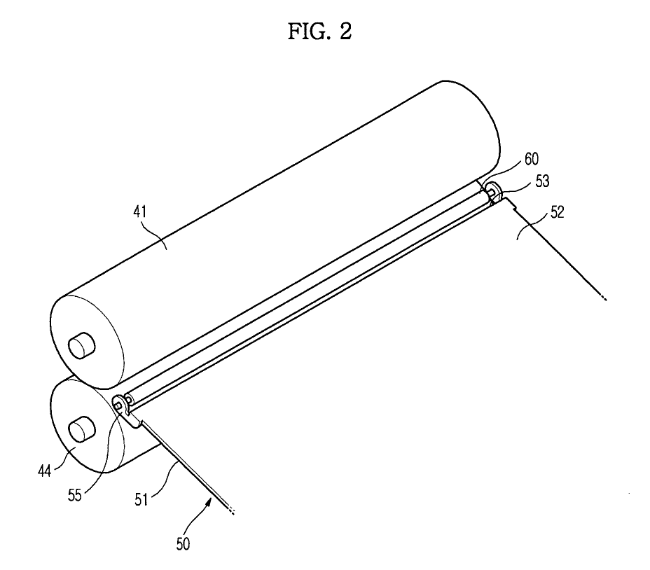

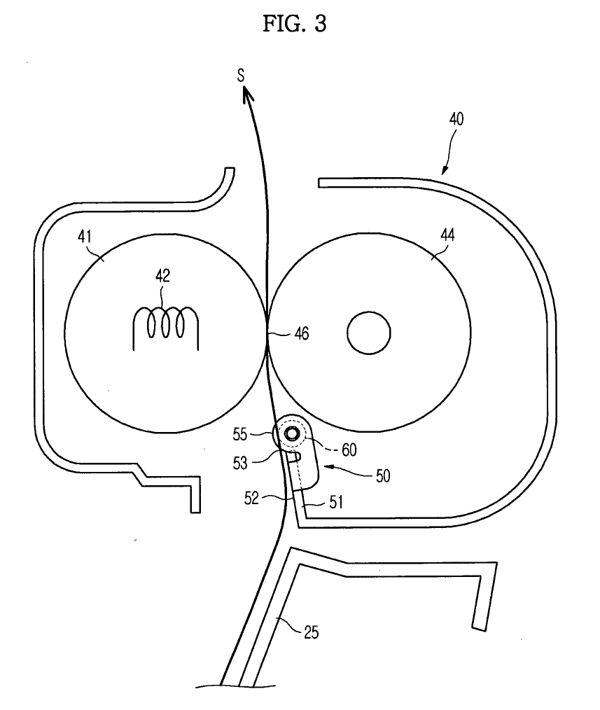

FIG. 2 is a perspective view of the guide unit provided in the fusing unit according to example embodiments, and FIG. 3 is a sectional view of the fusing unit according to example embodiments.

Referring to FIGS. 2 and 3, the guide unit 50 provided at the entrance of the fusing unit 40 includes a guide plate 51 having a guide surface 52 to guide the printing medium P, having passed through a transfer operation, into the fusing nip 46 between the heating member 41 and the press roller 44.

The guide plate 51 has a size corresponding to a width of the printing medium P. The guide plate 51 is supported by a fixed member provided at the entrance of the fusing unit 40 inclined by a predetermined angle suitable to guide the printing medium P to the fusing nip 46 of the fusing unit 40.

The printing medium P is moved while continuously coming into contact with the guide surface 52, i.e. an upper surface of the guide plate 51. In this case, the developer, i.e. toner particles attached to the printing medium P and scattered impurities around the printing medium P may be attached to the guide surface 52.

The impurities attached to the guide surface 52 may adhere and accumulate on the guide surface 52 by heating the fusing unit 40, and the front end of the printing medium P moved on the guide surface 52 may be caught by the adhered matter and may have difficulty entering the fusing unit 40. Moreover, the adhered matter may cause damage to the front end of the printing medium P resulting in jamming of the printing medium P.

To prevent the above described issues, the guide surface 52 may be coated with a fluoride resin material having high release ability to prevent attachment of impurities or to assure easy release of impurities attached thereto.

In the meantime, when the printing medium P is moved on the guide surface 52, the front end of the printing medium P comes into contact with the heating member 41 of the fusing unit 40 prior to being introduced into the fusing nip 46.

In this case, the printing medium P is moved and an opposite surface thereof continuously comes into linear contact with a distal end 53 of the guide surface 52. This may cause the impurities present on the printing medium P to move and adhere to the distal end 53 of the guide surface 52.

To prevent the impurities from adhering to the distal end 53 of the guide plate 51, the guide unit 50 according to the example embodiments may include a rotating member 60 rotatably arranged adjacent to the distal end 53 of the guide plate 51.

The rotating member 60 may be rotatably coupled to supporting plates 55 provided at both sides of the distal end 53 of the guide plate 51. The rotating member 60 may be a circular roller having a frictional surface to enable frictional rolling on the printing medium P.

When the printing medium P is introduced into the fusing nip 46 of the fusing unit 40, the rotating member 60 may prevent the surface of the printing medium P from coming into contact with the distal end 53 of the guide surface 52, thereby preventing the impurities from coming into frictional contact with and adhering to the distal end 53 of the guide surface 52.

The rotating member 60 may be made of a metal or heat-resistant resin material in consideration of operational efficiency thereof under a high temperature environment. A surface 65 of the rotating member 60 may be subjected to coating or surface treatment using a fluoride resin material having high release ability to prevent the impurities from adhering to the surface 65 of the rotating member 60.

In addition, to prevent restriction of rotation of the rotating member 60 by the impurities adhered to the surface 65 of the rotating member 60, the rotating member 60 may be spaced apart from the distal end 53 of the guide plate 51 by a predetermined distance.

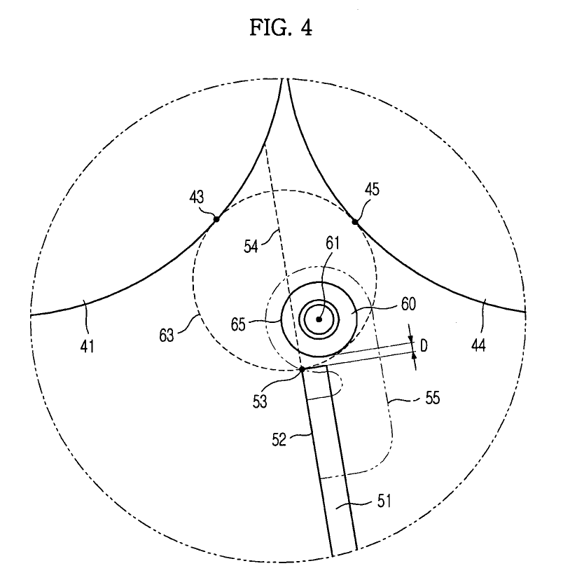

Referring to FIG. 4, a distance D between the rotating member 60 and the distal end 53 of the guide plate 51 may be in a range of about 0.5 mm to about 1.5 mm, for example, 0.5 mm to 1.5 mm.

In addition, the surface 65 of the rotating member 60 in the form of a circular roller may be positioned higher than, i.e. may protrude from an imaginary extension line 54 of the guide surface 52, to allow the printing medium P introduced into the fusing unit 40 to come into contact with the rotating member 60 rather than coming into contact with the distal end 53 of the guide plate 51.

More specifically, the surface 65 of the rotating member 60, adapted to come into frictional contact with the printing medium P, is positioned higher than the printing path S of the printing medium P moved on the guide surface 54 of the guide plate 51. As a result, as illustrated in FIG. 3, when the printing medium P is introduced into the fusing unit 40, the surface of the printing medium P is lifted from the distal end 53 of the guide surface 52 to not come into contact with the distal end 53 of the guide surface 52. This may prevent the impurities from coming into contact with and adhering to the distal end 53 of the guide surface 52.

In this case, to prevent the front end of the printing medium P moved on the guide surface 52 from being caught by the surface 65 of the rotating member 60 excessively protruding from the printing path S and from being subjected to movement load, a rotation center 61 of the rotating member 60 may be arranged lower than the extension line 54 of the guide surface 52.

The rotating member 60 in the form of a circular roller may have a smaller diameter than a diameter of a circumscribed circle 63 tangential to the distal end 53 of the guide surface 52, a surface 43 of the heating member 41 and a surface 45 of the press roller 44.

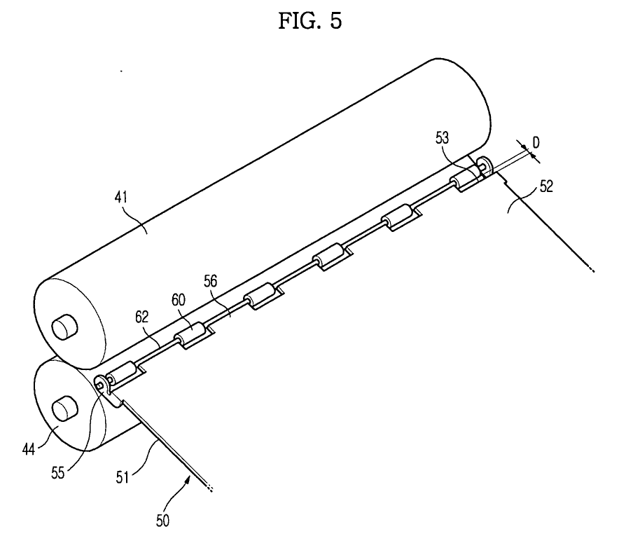

In example embodiments, as illustrated in FIG. 5, the rotating member 60, which is rotatably installed at a position spaced apart from the distal end 53 of the guide surface 52, may include a plurality of circular rollers. The circular rollers are rotatably installed to a shaft 62, both ends of which are supported by the supporting plates 55 provided at both sides of the guide plate 51, and are spaced apart from one another in an axial direction of the shaft 62.

Regarding the plurality of circular rollers, to prevent the front end of the printing medium P from escaping from the printing path S and being introduced into a gap D between the distal end 53 of the guide surface 52 and the rotating member 60, a plurality of guide ribs 56 may extend from the distal end 53 of the guide surface 52 toward the shaft 62 at positions corresponding to spaces between the plurality of circular rollers.

Accordingly, even if the front end of the printing medium P is curled, the guide ribs 56 may prevent the printing medium P moved on the guide surface 52 from entering the gap D between the distal end 53 of the guide surface 52 and the rotating member 60, resulting in increased reliability in accurate movement of the printing medium P.

The printing medium P, which has passed through the fusing unit 40 and carries the fused visible image, as illustrated in FIG. 1, is discharged outside from the top of the body 1 via the discharge unit 70.

The discharge unit 70 may include a discharge guide 71 defining a discharge path of the printing medium P and a plurality of discharge rollers 72 and 73 arranged on the printing path S. The discharge rollers 72 and 73 may be rotated in a given direction to discharge the printing medium P through a discharge region 74. Alternatively, the discharge rollers 72 and 73 may be rotated in an opposite direction to feed the printing medium P to a double-sided printing unit 80. The double-sided printing unit 80 returns the printing medium P, which has passed through the fusing unit 40 and carries the image completely formed on one surface thereof, to the developing unit 30.

The double-sided printing unit 80 returns the printing medium P, having one surface with the completely formed image, to the developing unit 30, to print images on both surfaces of the printing medium P.

The double-sided printing unit 80 may include a return guide 81 defining a return path of the printing medium P, and a series of return rollers 83 arranged on the return path of the printing medium P to feed the printing medium P.

The return guide 81 connects an entrance of the return path to the discharge path and also connects an exit of the return path to the register roller 27, thereby allowing the printing medium P located on the discharge path to be returned to the printing path by way of the return path via reverse rotation of the discharge rollers 72 and 73.

In this case, the printing medium P is inverted while passing through the return path prior to being returned to the printing path. As the inverted printing medium P sequentially passes through the developing unit 30 and the fusing unit 40, an image is formed on an opposite surface of the printing medium P.

In the meantime, since the printing medium P returned from the double-sided printing unit 80 into the fusing unit 40 already carries the image on the surface thereof, there may be a greater possibility of causing the impurities to adhere to the distal end 53 of the guide surface 52. However, in the image forming apparatus of the example embodiments, the printing medium P is moved and the surface of the printing medium P, having the formed image comes into rolling contact with the surface of the rotating member 60 rather than continuously coming into contact with the distal end 53 of the guide surface 52. This may retard adherence of the impurities caused by continuous contact between the distal end 53 of the guide surface 52 and the printing medium P, resulting in enhanced operational reliability.

As apparent from the above description, an image forming apparatus according to the example embodiments may prevent impurities from adhering to a distal end of a guide surface. This has the effect of remarkably reducing jamming of a printing medium due to adhered matter during movement of the printing medium.

Although example embodiments have been shown and described, it should be appreciated by those skilled in the art that changes may be made in these embodiments without departing from the principles and spirit of the disclosure, the scope of which is defined in the claims and their equivalents.

What is claimed is:

1. An image forming apparatus, comprising:
a paper supply unit to supply a printing medium;
a developing unit to form an image on the printing medium supplied from the paper supply unit;
a fusing unit to fuse an image transferred to the printing medium by applying heat and pressure to the image; and
a guide unit having a guide surface to guide the printing medium into the fusing unit,
wherein the guide unit includes a rotating member arranged adjacent to a distal end of the guide surface, the rotating member being rotatable while coming into rolling contact with the printing medium.

2. The image forming apparatus according to claim 1, wherein the rotating member includes a circular roller.

3. The image forming apparatus according to claim 2, wherein the distal end of the guide surface is spaced apart from a surface of the circular roller.

4. The image forming apparatus according to claim 2, wherein a surface of the circular roller is coated with a fluoride resin material having high release ability.

5. The image forming apparatus according to claim 2, wherein a surface of the circular roller protrudes from an extension line of the guide surface.

6. The image forming apparatus according to claim 2, wherein a rotation center of the circular roller is arranged lower than an extension line of the guide surface.

7. The image forming apparatus according to claim 2, wherein:
the fusing unit includes a heating member accommodating a heat source and a press roller to press the printing medium toward the heating member; and
the circular roller has a size smaller than a diameter of a circumscribed circle tangential to the distal end of the guide surface, a surface of the heating member and a surface of the press roller.

8. The image forming apparatus according to claim 2, wherein a distance between the distal end of the guide surface and the surface of the circular roller is in a range of about 0.5 mm to about 1.5 mm, for example, 0.5 mm to 1.5 mm.

9. The image forming apparatus according to claim 1, wherein the rotating member includes a plurality of circular rollers rotatably installed to a shaft and spaced apart from one another in an axial direction of the shaft.

10. The image forming apparatus according to claim 9, wherein at least one guide rib extending toward the shaft is provided at the distal end of the guide surface at a position corresponding to a space between the plurality of circular rollers.

11. An image forming apparatus comprising a guide unit installed at an entrance of a fusing unit used to heat and fuse a developer image transferred to a printing medium, the guide unit having a guide surface to guide the printing medium to a fusing nip defined between a heating member and a press roller of the fusing unit,
wherein a circular roller is provided at a distal end of the guide surface and is rotated to perform frictional rolling on a surface of the printing medium passing through the fusing nip.

12. The image forming apparatus according to claim 11, wherein the circular roller is made of one of a metal and heat-resistant resin material, and a surface of the circular roller is coated with a fluoride resin material having high release ability.

13. The image forming apparatus according to claim 11, wherein a surface of the circular roller protrudes from an extension line of the guide surface.

14. The image forming apparatus according to claim 13, wherein a rotation center of the circular roller is arranged lower than the extension line of the guide surface.

15. The image forming apparatus according to claim 14, wherein the circular roller has a size smaller than a diameter of a circumscribed circle tangential to the distal end of the guide surface, a surface of the heating member and a surface of the press roller.

16. The image forming apparatus according to claim 15, wherein the surface of the circular roller is spaced apart from the distal end of the guide surface.

17. The image forming apparatus according to claim 16, further comprising a shaft to which the circular roller is rotatably installed,
wherein a plurality of circular rollers is installed to the shaft and each of the plurality of circular rollers is spaced apart from one another in an axial direction of the shaft.

18. The image forming apparatus according to claim 17, wherein at least one guide rib extending toward the shaft is provided at the distal end of the guide surface at a position corresponding to a space between the plurality of circular rollers.

19. A method, comprising:
guiding a printing medium into a fusing unit by guiding the printing medium along a guide surface;
rotating a circular roller against the printing medium, the circular roller located adjacent to a distal end of the guide surface to move toward the printing medium into the fusing unit, a gap between the distal end of the guide surface and the circular roller being from 0.5 mm to 1.5 mm;
forming an image onto the printing medium in the fusing unit; and
fusing the image onto the printing medium by applying heat and pressure to the image.

20. An apparatus, comprising:
a guide unit to guide a printing medium into a fusing unit by guiding the printing medium along a guide surface;
a rotation unit to rotate a circular roller against the printing medium, the circular roller located adjacent to a distal end of the guide surface to move toward the printing medium into the fusing unit, a gap between the distal end of the guide surface and the circular roller being from 0.5 mm to 1.5 mm;
a forming unit to form an image onto the printing medium in the fusing unit; and
a fusing unit to fuse the image onto the printing medium by applying heat and pressure to the image.

21. The method of claim 19, wherein a surface of the circular roller includes a material having high releasability.

22. The apparatus of claim 20, wherein a surface of the circular roller includes a material having high releasability.

23. The method of claim 19, further comprising lifting the printing medium from the distal end of the guide surface and preventing impurities from adhering to the distal end of the guide surface.

24. The apparatus of claim 20, wherein the rotating unit lifts the printing medium from the distal end of the guide surface and prevents impurities from adhering to the distal end of the guide surface.
